(19) United States
(12) Patent Application Publication
(10) Pub. No.: US 2003/0188145 A1
(43) Pub. Date: Oct. 2, 2003

(54) Method and system for peripheral device installation

(76) Inventors: Tanna Marie Richardson, Portland, OR (US); Ronnie Neil Patton, Lake Oswego, OR (US)

Correspondence Address: Scott C. Krieger, Patent Counsel, Sharp Laboratories of America, Inc., 5750 NW Pacific Rim Boulevard, Camas, WA, 98607, US

(21) Appl. No.: 10/112,153

(22) Filed: Mar. 27, 2002

(51) Int. Cl. G06F 9/44; G06F 15/177; G06F 9/24; G06F 9/00

(52) U.S. Cl. 713/1

(57) ABSTRACT

Embodiments of the present invention comprise systems and methods for enabling a computing device to use a peripheral device.

### BACKGROUND OF INVENTION

In many environments, a peripheral device such as a printer is connected to a network. Connecting the device to the network allows multiple users to take advantage of the various capabilities of the device. In order for a user to access the device over a network, however, the user must acquire or have access to the device's driver. Users may also need additional information in order to use or “install” the device. For example a user may need the name of the queue assigned to the device, the device's network path, and the device's name (commonly referred to as the device name). Once the user acquires this information, the driver can be installed on the user's PC or alternatively, pointers may be used to identify or “point to” the location of the driver.

If, however, the driver is not available on the network or if the user is unable to obtain the requisite information such as, for example, the device name, the user will not be able to communicate with the device. Consequently, a systems administrator may be required to assist the user in installing the device. In this regard, it would be advantageous to have a means by which a user, who desires to use a peripheral device, could obtain the requisite installation information and install the peripheral device with ease, convenience, and expediency and without the aid of a systems administrator.

### SUMMARY

Embodiments of the present invention comprise methods and systems by which a peripheral device communicates with a computing device, such as, for example, a PC. In some embodiments of the invention, a method of distributing active information, comprising, but not limited to, a driver is described. The active information is distributed from the peripheral device to a user desiring to communicate with or use the peripheral device. The method comprises the acts of identifying a user device through a user interface on the peripheral device and enabling the user device with the active information.

### BRIEF DESCRIPTION OF DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a diagram showing a peripheral device in communications with a computing device.

FIG. 2 is a diagram showing a peripheral device in communications with a computing device via a network.

FIG. 3 is a diagram showing an embodiment of the present invention comprising a peripheral device coupled to a computing device via a network comprising a server and a website.

FIG. 4 is a diagram showing several peripheral devices coupled to several computing devices via a network, which may comprise a peer-to-peer connection and/or a wireless connection.

FIG. 5 is a diagram showing a peripheral device comprising an integral user interface, a memory unit containing active information, and a network interface card.

FIG. 6 is a diagram showing an MFP comprising an integral user interface, a memory containing active information, a recording device, and a network interface card.

FIG. 7(a) is a diagram showing a user interface for an embodiment of the present invention comprising a keypad whereby a user's destination address can be entered.

FIG. 7(b) is a diagram showing a user interface for an embodiment of the present invention comprising a recording device.

FIG. 8 is a diagram showing a user interface for an embodiment of the present invention comprising several options by which active information can be directed to a destination address.

FIG. 9 is a diagram showing steps used to direct active information to a recording device.

FIG. 10 is a diagram showing steps used to direct active information to a destination address.

FIG. 11 is a diagram showing steps used to direct active information to a destination address by selecting a destination address from a list of destination addresses.

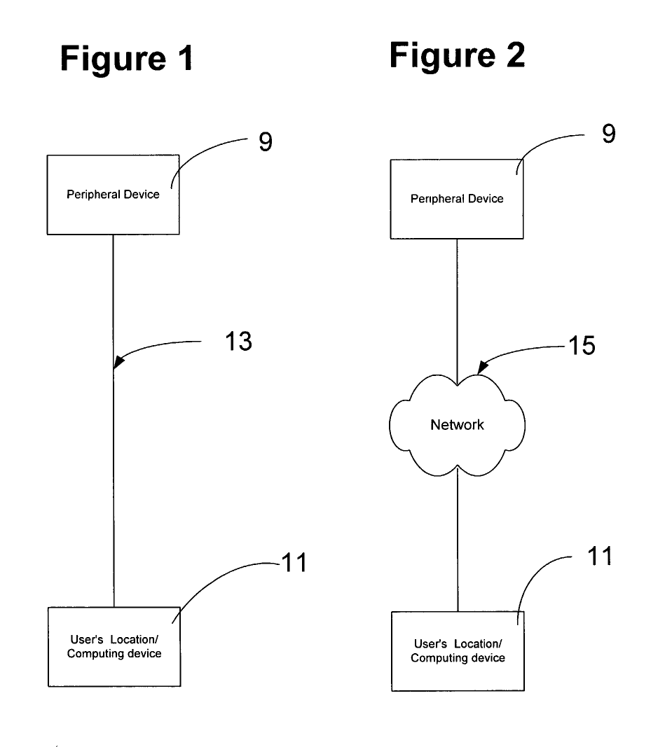

The figures listed above are expressly incorporated as part of this detailed description. It will be readily understood that the components of the present invention, as generally described and illustrated in the figures herein, could be arranged and designed in a wide variety of different configurations. Thus, the following more detailed description of the embodiments of the systems and methods of the present invention, as represented in FIGS. 1 through 11 is not intended to limit the scope of the invention, as claimed, but it is merely representative of the presently preferred embodiments of the invention.

### DETAILED DESCRIPTION

Embodiments of the present invention provide a means by which a user, who desires to use or install a peripheral device, may obtain the requisite information and enable the device with ease, convenience and expediency. As a non-limiting example, if a new printer is installed or relocated on a network, embodiments of the invention will allow the user to access or acquire the printer's driver along with additional information needed to print to or install the printer. The user can obtain this information by engaging the printer's user interface. Thus, in embodiments of the present invention, a user desiring to print to the printer can acquire the printer's driver by entering a destination address (at the printer's user interface (UI)) to which the driver and accompanying information or a link to the driver and accompanying information, will subsequently be electronically transmitted. Before describing embodiments of the present invention in more detail, definitions of various terms, which apply thought out this specification and related claims, are warranted:

The term peripheral or peripheral device may refer to any device connectable to a computing device such as a computer. Peripheral devices may comprise, but are not limited to, printers, copiers, scanners, fax machines, disk drives, media recorders, displays or combinations thereof. A particular combination of devices comprising a printer, copier, scanner, and fax machine may be referred to as a multifunctional peripheral (MFP). Peripheral devices may also comprise digital imaging systems such as projectors, video recorders, cameras and webcams.

Printers or printing systems include devices generally capable of marking or directing a marking substance towards a tangible medium such as paper. Printers or printing systems comprise laser printers, inkjet printers, or drum printers as well as other devices.

Computing devices or user computing devices may comprise personal computers, workstations, minicomputers, mainframes, supercomputers and personal digital assistants (PDAs) comprising palm computing devices.

Active information comprises information that contains executable code or links that will direct a user to a location where executable code can be obtained or executed. Active information may also comprise information that is executable by other programs. In some embodiments of the present invention, active information comprises executable data, which may comprise drivers, print processors, and print monitors.

Other useful information may be passed along with the active information. This information comprises the queue name of the peripheral device, user guides, help files, device name, and network path.

Networks or computer networks generally include two or more electronic devices that have the ability to communicate. The electronic devices may communicate via local-area networks (LANs), wide-area networks (WANs), campus-area networks (CANs), metropolitan area networks (MANs) or home-area networks (HANs). A network may also comprise a computing device coupled to a peripheral device.

A user interface is the junction between a user and an electronic device. The user interface may comprise one or more commands or menus through which a user communicates with a device. A user interface may also comprise a recording device wherein the user communicates one or more commands by inserting a removable media element into the recording device.

References to Microsoft Windows or Windows operating system may refer to any version or variation of a Microsoft Windows ® operating system comprising Windows 95®, Windows 98®, Windows NT®, Windows 2000®, Windows ME®, Windows XP® and others. While exemplary embodiments of the present invention may be directed to a Windows operating system and environment, systems and methods directed to other operating systems such as Macintosh®, UNIX, DOS, Linux, MVS, Netware, and others are to be contemplated within the scope of the present invention.

An environment in which embodiments of the present invention operate is described in reference to FIG. 1 wherein a peripheral device 9 communicates with a computing device 11 via a connector 13. The peripheral device 9, for example, could be a printer, scanner, fax machine or image projection system whereas the computing device could be a PC, palm PC, laptop, or personal digital assistant.

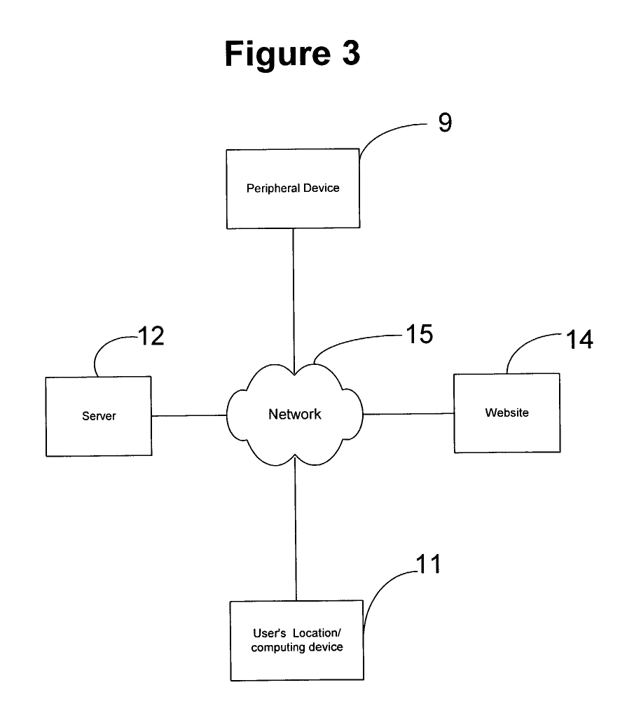

An environment in which embodiments of the present invention operate is also described in reference to FIG. 2. Here, the link between the peripheral device 9 and the computing device 11 is a network 15. The network 15 may facilitate several paths by which the peripheral device 9 and the computing device 11 communicate. The network 15 may also comprise a server 12 and/or a website 14 as illustrated in reference to FIG. 3.

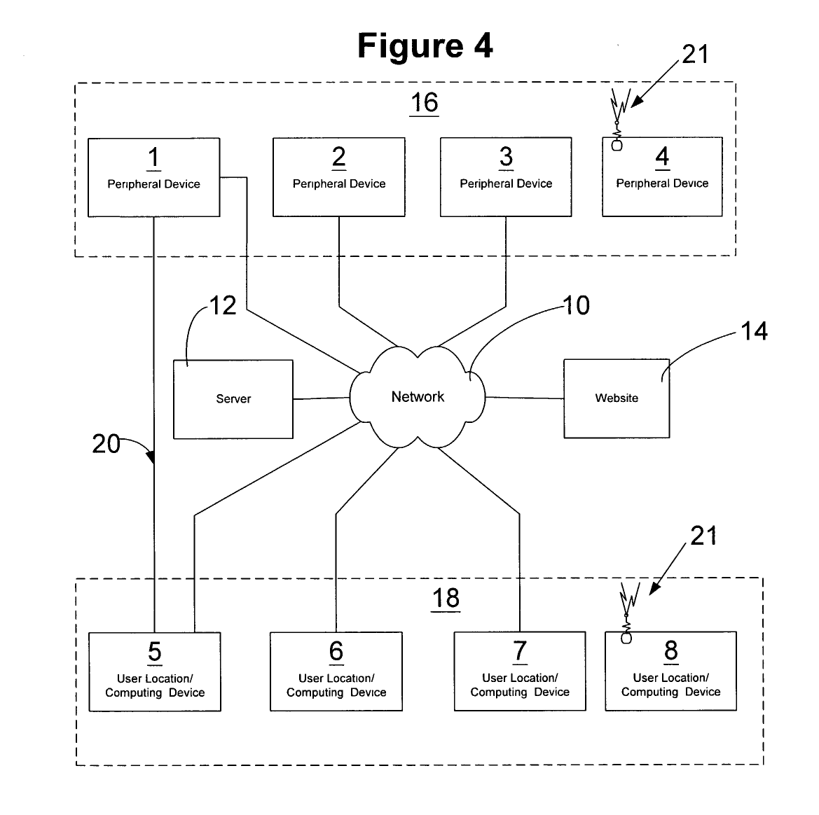

A more complex network environment, in which embodiments of the present invention operate, is described in reference to FIG. 4. A network 10, in the illustrated embodiments of the present invention, is a conventional TCP/IP network which may support a server 12 and/or website 14. Although a TCP/IP network is described, those skilled in the art will recognize that various networks or network protocols could be used in an embodiment of the invention. Electronic devices, such as peripheral devices 1-4, collectively 16, and computing devices 5-8, collectively 18, are connected to the network 10 and are represented as nodes. Each node in the network has a unique network address, sometimes called a Data Link Control (DLC) address, Media Access Control (MAC) address, or internet protocol (IP) address. The format of an address, such as, for example, an IP address is a 32-bit numeric address written as four numbers separated by periods.

Alternatively, in some embodiments of the present invention, the network 10 may comprise a peer-to-peer connection 20 as shown between peripheral device 1 and computing device 5. A peer-to-peer connection 20 may comprise a direct link between peripheral device 1 and computing device 5. Peripheral device 1 and computing device 5 can forward each other's information packets directly using the peer-to-peer connection 20 as an alternative to using a more complex network 10. Those skilled in the art, however, will recognize that a peer connection 20 could be established between peripheral device 1 and computing device 5 using various paths through network 10. An independent peer-to-peer connection 20 is generally a faster, more secure connection between peripheral device 1 and computing device 5 since fewer data packets are channeled to multiple nodes which exist in the network 10.

Network 10 may also comprise wireless components, which may be used to connect peripheral devices 16 to computing devices 18 or any other elements in the network 10. Thus, high-frequency radio waves or other wireless media may be used as the communications medium between peripheral devices 16, computing devices 18, and other network elements rather than electrical wires or fibers typically used in a wired network. Those skilled in the art, however, will recognize that other wireless communications media may also be used between peripheral devices 16 and computing devices 18, such as, for example Bluetooth, IrDA and IEEE 802.11 technologies. A computing device may be referred to as being at a “user's location” throughout this specification. Those skilled in the art will recognize, however, that the user's location includes any location from which the user accesses the network 10 using a computing device. A user location may also include the location of more than one user on the network.

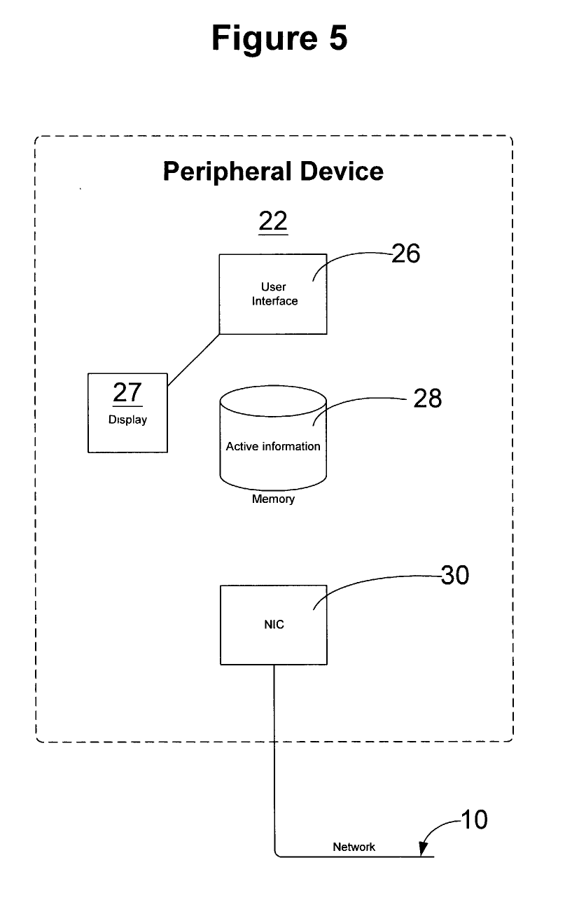

A peripheral device 22, shown in reference to FIG. 5, may comprise a UI 26, a memory unit 28, and a network interface card (NIC) 30. The UI 26, in the illustrative embodiments, may also comprise a display 27, which assists a user in communicating with or engaging the peripheral device 22. For example, a user desiring to use a copy function of peripheral device 22 puts the device in a copy mode by pressing a copy button on the device's UI 26.

A memory 28, as shown in reference to FIG. 5, may be volatile or nonvolatile such as RAM or ROM respectively. Additionally, in some embodiments of the present invention, the memory comprises a memory allocation. A memory allocation may comprise retrievable active information, which may comprise a driver (occasionally referred to as a device driver), status monitor, and information such as queue name, network path, print processor, user guides, help files and other device utilities. Alternatively, the memory allocation may contain links to retrievable information including queue name, status monitor, network path, user guides, help files and other device utilities.

The NIC 30, as shown in reference to FIG. 5, allows the peripheral device 22 to be connected to a network 10. Once the peripheral device 22 is connected to the network 10, a computing device, such as, for example, computing device 6 shown in FIG. 4, can communicate with peripheral device 22 or other devices connected to the network. For example, a computing device such as a PC can send a print job to a peripheral device configured for printing via the network 10 and subsequently obtain the status of the print job.

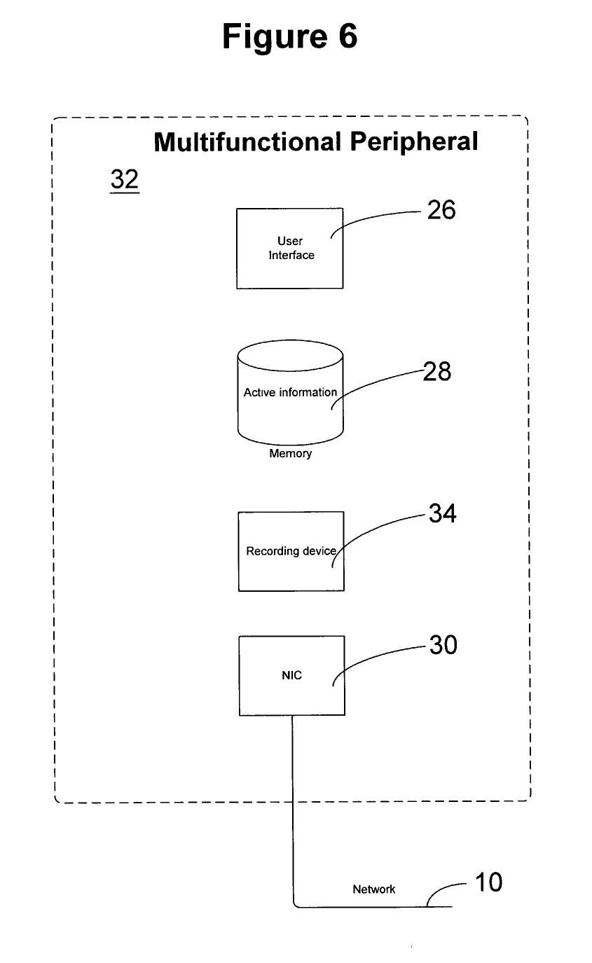

A peripheral device such as a multifunctional peripheral (MFP) device 32 may also comprise a recording device as shown in reference to FIG. 6. A recording device 34 allows information stored in memory 28 to be recorded on transportable media such as magnetic and/or optical disks. For example, the recording device 34 allows active information taken from memory 28 to be stored on floppy disks, CDs, compact flash, smart media or other removable storage devices. Alternatively, the recording device 34 may record data onto removable tape cartridges or other media.

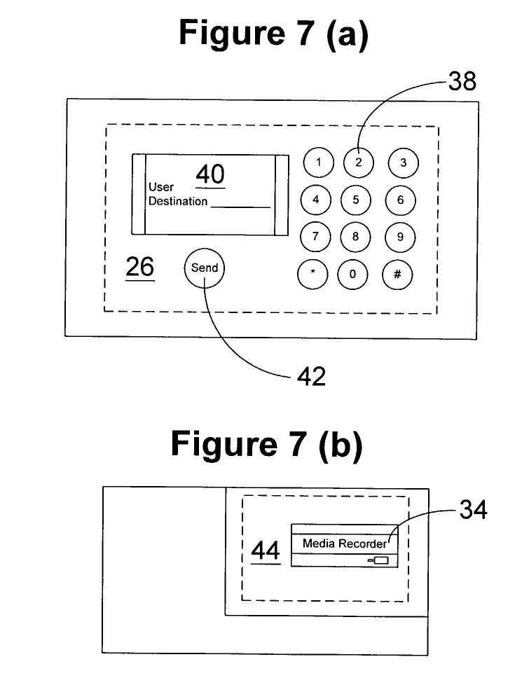

In some embodiments of the present invention, as shown in reference to FIGS. 6 and 7(a), a user desiring to print to the MFP 32 may, from the MFP's UI 26, make a request for active information. The UI 26 may comprise a keypad 38 (although a software keyboard, external keyboard, or number keypad could be used) and an LCD screen 40. In some embodiments of the present invention, a request for active information can be made by entering a user's address. An address or destination address may include, for example, an email address or an IP address. Those skilled in the art will recognize, however, that a destination address could include a telephone or ISDN number, fax number, an address associated with global positioning system (GPS) coordinates, or other data.

Once the destination address is entered, the user may initiate the sending of the active information by pressing a send button 42 or some other input means. The active information is copied from memory 28 and transmitted to the desired destination via NIC 30. In some embodiments of the present invention, the active information is transmitted as an attachment to an email comprising the destination address of the user. The user can then retrieve or otherwise activate or enable the active information at the location of the user's PC when necessary. Additionally, instead of attaching the information to the email, a header containing the destination address of the user can be added to the active information. Although, in some embodiments of the present invention, the active information is attached to an email, those skilled in the art will recognize that the active information could be sent using various protocols including FTP and TFTP. Moreover, the active information may be sent to a remote location, such as a shared drive, accessible by the user or users whereby the active information may be acquired or accessed.

An alternative UI is shown in reference to FIG. 7(b). In this figure, a recording device 34 capable of writing to a removable media element placed in the recording device 34 serves as the UI indicated by reference 44. In these embodiments, the active information for the device is automatically copied from memory 28 to removable media placed in the recording device 34 when the removable media is inserted or upon completing some other actions. Once the active information has been copied to the removable media, a user desiring to use the device can remove the media and insert the media into the desired computing device. The user can then load and execute the active information stored on the removable media thereby allowing the user to use the device associated with UI 44.

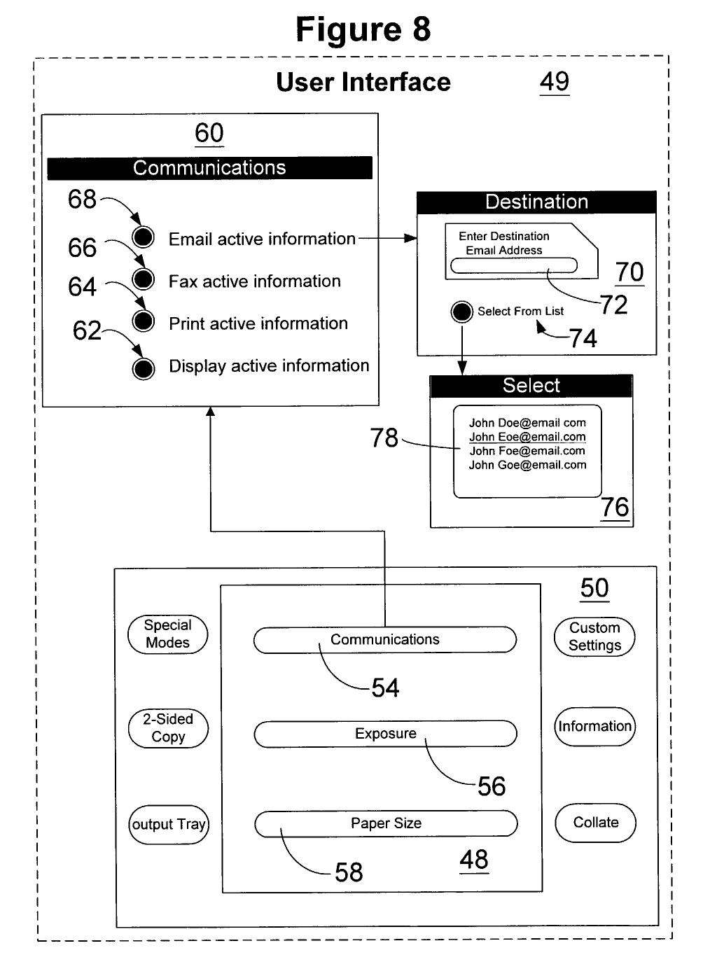

Some embodiments may utilize an alternative UI, containing various user options as shown in reference to FIG. 8. Some of the user options are shown on an LCD screen 48 and are activated by touching the screen or other user input means. Additional user options are located on the perimeter 50 of LCD screen 48. User options located on the perimeter of LCD screen 48 may comprise “special device modes,” “2-sided copy,” “output tray selection”, “custom settings,” “information”, and “collation” options. User options included on LCD screen 48 may comprise “paper size” 58, “exposure” 56, and “communications” 54. In some embodiments of the present invention, activating the communications option 54 directs the user to the “communications window” 60. The communications window 60 comprises several options for obtaining information relevant to communicating with the device associated with the UI 49. These options may comprise “display active information” 62, “print active information” 64, “fax active information” 66 and “email active information” 68.

The display active information option 62, allows the non-executable portion of the active information to be shown on the LCD screen 48. For example, information displayed on the LCD screen 48, upon choosing the display active information option 62, may comprise the device's IP address, queue name, network path, device name, driver and status monitor location (tells the user if the driver and status monitor are stored on the device 32 or the network 10), and other user/instruction information.

The information displayed on the LCD screen 48 may incorporate links that will direct the user to additional information that may be located on the network 10. The print active information option 64 and fax active information option 66 will provide the user with analogous information retrievable under the display active information option 62. In some embodiments of the present invention, the user selects the desired information by scrolling through an index of the information or running a keyword search. Once the desired information is chosen, the user then selects one or more of the aforementioned options in which to view the information.

The email active information option 68 comprises additional windows including a “destination window” 70 and a “select window” 76. The destination window 70 comprises a dialogue box 72, which allows the user to enter a destination email address to which the active information is to be sent. Alternatively, the user can choose an option to enable address selection from a list 74 which opens the select window 76. The “select from list” option 74 may comprise a list of email addresses of all users connected to the network. The user can then choose the destination email address 78 (or destination addresses) to which the active information will be sent. For example, if John Eoe, desires to send the active information to himself, he will select his email address, 78 John_Eoe@email.com, from the list 78. Subsequently, John Eoe will receive an email message with the active information attached. John can then execute or load the active information. If the active information John requested includes the print driver, once John receives the email from the device, he can install the device's driver on his PC using a convention Microsoft Windows Add Printer Wizard or some other program. Alternatively, John could send the active information to another user on the network 10 such as, for example, John Doe at John_Doe@email.com.

Although the active information may reside on the device, those skilled in the art will recognize that the active information may reside on a sever 12 or website 14 or other devices coupled to the network 10 (see FIG. 4). Alternatively, some of the active information may reside on the device and some on a device coupled to the network 10. In embodiments of the invention where a portion or all of the active information resides external to the device, the user would request, from a UI on the device, the active information as previously described. Accordingly, the user will provide a destination address, such as for example, and email address or insert removable media into a recording device 34 as shown in FIG. 7(b). The device will then send an email to the user destination containing a link to the server 12, website 14 or other devices coupled to the network from which the requested active information can be acquired and subsequently executed.

In some embodiments of the present invention, an MFP 32, upon receiving the request from the user, will retrieve the active information from the server 12, website 14 or other devices coupled to the network 10 and send the active information to the destination address via FTP, TFTP, email or some other proprietary or nonproprietary information transport mechanism. Alternatively, the retrieved active information may be copied directly to the removable media element inserted in the recording device 34 once the MFP 32 obtains the active information. When active information is stored on a server 12 or website 14, an administrator can more conveniently update the active information as needed.

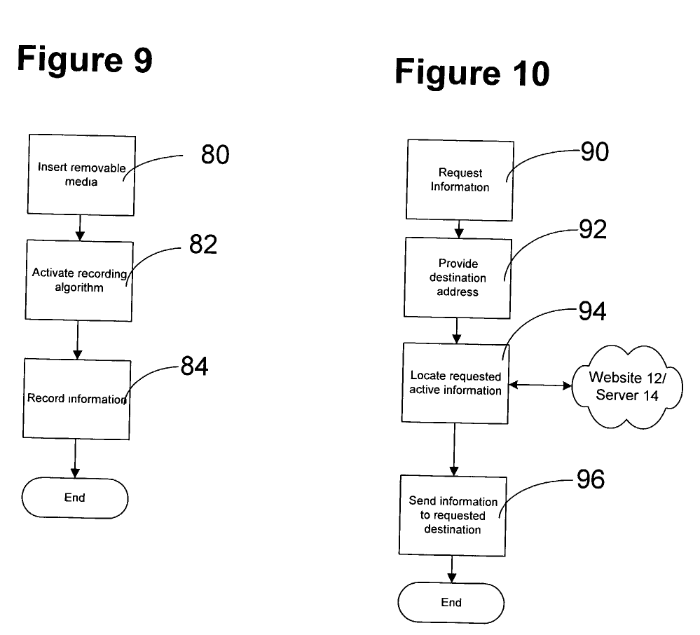

FIG. 9 is a diagram showing steps used, in embodiments of the present invention, to direct active information to a recording device 34. To begin this process, the user inserts removable media (occasionally referred to as a computer-readable media) into a recording device 34 as indicated in step 80. Once the removable media is inserted into the recording device 34, a copy algorithm is automatically activated 82. The copy algorithm identifies the active information, which may be located in the memory 28 of the MFP 32. Next, the active information is copied to the removable media in the recording device 34. Once the active information is copied 84, the program may end.

FIG. 10 is a diagram showing steps used, in embodiments of the present invention, to direct active information to a destination address. To begin this process, a user may, from the UI 26 of the device, requests active information as illustrated in step 90. The user then provides a destination address as shown in step 92. An algorithm is then initiated which seeks to locate the active information, 94. The active information may be stored locally in the MFP's memory 28 or/and on the server 12, website 14, or other devices connected to the network 10. The information may be retrieved and attached to the destination address or a link to the active information may be included in the transmitted information. Once the information is obtained, the active information is then sent to the destination address indicated by step 96.

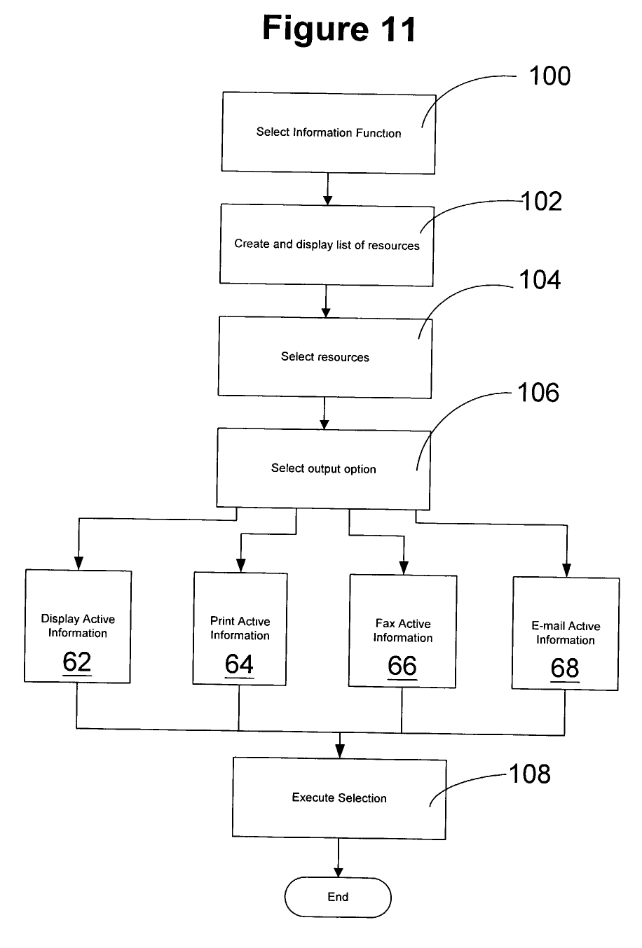

FIG. 11 is a diagram showing steps used to direct active information to a destination address by selecting a destination address from a list of destination addresses. To begin this process, a user may select a communications option 54 (FIG. 8) on a device's UI 100. Following the selection of the communication option 54, a list of resources is displayed 102 on the UI. These resources may comprise the IP address of the device, queue name, network path, device name, driver or driver location, or status monitor location, and other user/instruction information. Once the resources are selected 104, the user chooses an output option 106. The output options may comprise displaying the active information 62, printing the active information 64, faxing the active information 66 and or emailing the active information 68. Once the output option is selected, the selection is executed 108.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within the scope of the claims.

What is claimed is:

1. A method of distributing active information from a peripheral device to a user, said method comprising:
indicating a user location through a user interface on said peripheral device; and
transferring said active information to said user location.

2. The method of claim 1 wherein said active information is a driver for said peripheral device.

3. The method of claim 1 wherein said user location is an IP address.

4. The method of claim 1 wherein said user location is an e-mail address.

5. The method of claim 1 wherein said transferring comprises transmitting said active information from said peripheral device to said user location.

6. The method of claim 1 wherein said transferring comprises transmitting said active information from a site to said user location.

7. The method of claim 1 wherein said transferring said active information to said user location comprises establishing a network connection between said peripheral device and said user location.

8. The method of claim 1 wherein said transferring said active information to said user location comprises establishing a direct connection between said peripheral device and said user location.

9. A method of distributing a driver for a peripheral device with an integral user interface, said method comprising:
indicating a user location through said integral user interface, said user location defining a means of communicating with a specific user computing device;
storing said peripheral device driver in a memory; and
sending said peripheral device driver to said user location in response to said indicating.

10. The method of claim 9 wherein sending said peripheral device driver to said user comprises sending said peripheral device to a computing device.

11. The method of claim 9 wherein said indicating comprises inserting media into a media recording device that is integral with said peripheral device, thereby indicating the media as said user location and whereby said sending comprises automatically recording said driver on said media.

12. The method of claim 11 wherein said sending comprises recording said driver on said media.

13. The method of claim 9 wherein said indicating consists solely of inserting media into a media recording device that is integral with said peripheral device.

14. A method of enabling use of a network peripheral device, said method comprising:
storing a driver for said network peripheral device in a memory wherein said memory is integral to said network peripheral device;
indicating a user computing device network location through a user interface integral to said network peripheral device; and
sending said driver from said memory to said user computing device in response to said indicating.

15. The method of claim 14 wherein said indicating a user computing device network location comprises providing an Internet address.

16. The method of claim 14 wherein sending said driver from said memory to said user computing device comprising associating said driver with an electronic mail message.

17. The method of claim 14 wherein sending said driver from said memory to said user computing device comprises transmitting said driver via a file transfer protocol.

18 The method of claim 14 wherein storing a driver for said network peripheral device comprises storing said driver on a network accessible device and storing a link to said driver and whereby said sending comprises sending said link to said user location.

19. The method of claim 14 wherein sending said driver from said memory comprises sending additional information with said driver.

20. The method of claim 14 wherein sending said driver from said memory comprises selecting information from the group consisting of user guides, print monitors, print processors, queue names, device names, and help files.

21. A method of distributing a peripheral device driver, said method comprising:
storing a peripheral device driver executable in a memory; and
recording said device driver executable on a computer-readable medium via a media recorder integral with said peripheral device

22. The method of claim 21 wherein said storing a peripheral device driver executable in a memory comprises storing the device driver in a memory external to said peripheral device and providing a link to said device driver, said link being executable in a memory integral to said peripheral device.

23. The method of claim 21 wherein recording said device driver comprises activating a recording algorithm whereby said media recorder automatically records said device driver on said computer-readable medium when said medium is places in said recorder.

24. The method of claim 21 wherein said recording said device driver is in response to the insertion of media into said recorder.

25. A system for enabling use of a peripheral device by a user computing device, said system comprising:
a peripheral device comprising an integral user interface and communications capability;
a memory for storing configuration data;
a user computing device comprising communications capability; and
a communications connection between said peripheral device and said user computing device; wherein a user may designate said user computing device through said user interface and said peripheral device may send said configuration data to said user computing device thereby allowing said user computing device to be configured to use said peripheral device.

26. The system of claim 25 wherein said peripheral device comprises a recorder integral thereto.

27. The system of claim 25 wherein said memory for storing configuration data comprises executable links enabling acquisition of additional configuration data.

28. The system of claim 25 wherein said configuration data is indexed and selectable by a user engaging said user interface.

29. A peripheral device having a communications connection to a user computing device comprising:
an integral user interface; and
a memory wherein active information is accessibly stored, the user of said peripheral device may designate said user computing device through said user interface and said peripheral device may send said active information to said user computing device thereby allowing said user computing device to be configured to use said peripheral device.

30. The peripheral device of claim 29 wherein said active information is displayable on said integral user interface.

31. The peripheral device of claim 29 wherein said active information is printable by said peripheral device.

32. The peripheral device of claim 29 wherein said active information is transmitted by a fax machine.

33. The peripheral device of claim 29 wherein said active information is transmitted by electronic mail to said user computing device.

34. The peripheral device of claim 29 wherein said active information is transmitted by a file transfer protocol to said user computing device.

35 The peripheral device of claim 29 wherein said active information is stored external to said peripheral device, said active information being assessable to said user computing device upon a request of said peripheral device.

36. A computer readable medium comprising instructions for configuring a peripheral device for use by a user computing device, said instructions comprising the acts of:
indicating a user location through an integral user interface on said peripheral device, said user location enabling communication with said user computing device;
storing said peripheral device driver in a memory; and
sending said peripheral device driver to said user computing device in response to said indicating.

37. A computer data signal embodied in an electronic transmission, said signal having the function of configuring a peripheral device for use by a user computing device, said signal comprising instructions for:
indicating a user location through an integral user interface, said user location defining a means of communicating with said user computing device;
sending said peripheral device driver to said user computing in response to said indicating.
